(19) United States
(12) Patent Application Publication
(10) Pub. No.: US 2009/0284123 A1
(43) Pub. Date: Nov. 19, 2009

(54) ELECTRON-EMITTING DEVICE AND IMAGE DISPLAY APPARATUS

(75) Inventors: Shoji Nishida, Hiratsuka-shi (JP); Koki Nukanobu, Machida-shi (JP); Takuto Moriguchi, Chigasaki-shi (JP); Takeo Tsukamoto, Atsugi-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/429,654

(22) Filed: Apr. 24, 2009

(30) Foreign Application Priority Data
May 14, 2008 (JP) 2008-126629

(51) Int. Cl. H01J 1/00

(52) U.S. Cl. 313/311

(57) ABSTRACT

An image display apparatus uses electron-emitting devices each having: a pair of device electrodes on an insulating substrate; and an electroconductive film connecting the device electrodes. The insulating substrate has concave portions in a gap between the device electrodes. The film has opening portions having a first gap in a region adjacent to the opening portions along such a gap. A carbon film having a second gap is formed in the first gap and has extending portions extending from side surfaces of the concave portions toward the bottom. The extending portions of the adjacent carbon films are not coupled.

### BACKGROUND OF THE INVENTION

1. Field of the Invention

The present invention relates to an electron-emitting device and an image display apparatus using the electron-emitting devices.

2. Description of the Related Art

As an electron-emitting device, there is an electron-emitting device of a field emission type, a surface conduction type, or the like.

As a step of forming the surface conduction type electron-emitting device in the related art, first, a pair of device electrodes are formed onto an insulating substrate. Subsequently, the pair of device electrodes are connected through an electroconductive film. By applying a voltage between the device electrodes, a process called “energization forming” for forming a first gap into a part of the electroconductive film is executed. The energization forming operation is a step of supplying a current to the electroconductive film and forming the first gap into a part of the electroconductive film by a Joule heat generated by the current. By the energization forming operation, a pair of electroconductive films which face through the first gap are formed. Subsequently, a process called “activation” is executed. The activation operation is a process for applying a voltage between the pair of device electrodes in a gas atmosphere containing carbon. Thus, electroconductive carbon films can be formed onto the substrate in the first gap and the electroconductive films near the first gap. Thus, the electron-emitting device is formed.

When an electron is emitted from the electron-emitting device, an electric potential which is applied to one of the device electrodes is set to be higher than an electric potential which is applied to the other device electrode. By applying the voltage between the device electrodes as mentioned above, a strong electric field is caused in a second gap. It is, consequently, considered that electrons tunnel from a number of portions (a plurality of electron-emitting regions) in a portion constructing an outer edge of the second gap corresponding to an edge of the carbon film connected to the device electrode on the low potential side and a part of the electrons are emitted.

In the Official Gazettes of Japanese Patent No. 2627620, Japanese Patent Application Laid-Open No. 2002-352699, and Japanese Patent Application Laid-Open No. 2004-055347, there have been disclosed such techniques that a variation in first gap at the time of the energization forming operation, a discharge breakdown of the electron-emitting region at the time of the activation operation, and a breakdown of the electron-emitting region due to an ion impact or the like upon driving are suppressed by shape control of the electroconductive film or by a plurality of divided electroconductive films.

A substrate having an electron source constructed by arranging a plurality of such electron-emitting devices and a substrate having a light-emitting film made of phosphor or the like are arranged so as to face each other and the inside is maintained in a vacuum state, so that an image display apparatus can be constructed.

In a recent image display apparatus, it is demanded that a display image can be stably displayed with a little luminance fluctuation for a long time. For this purpose, in the image display apparatus having the electron source constructed by arranging a plurality of electron-emitting devices, it is demanded that each electron-emitting device maintains good characteristics with a little fluctuation for a long time.

However, there is such a problem that in the case where the surface conduction type electron-emitting device in the related art is driven, when a sheet resistance of the electroconductive film is small, a fluctuation in electron-emission amount (phenomenon in which a fluctuation in electron-emitting current occurs in a short time) occurs.

It is considered that the electrons tunnel from a number of portions constructing an outer edge of the gap corresponding to a part of the edge of one of the carbon films as mentioned above. For example, when the electric potential of one of the device electrodes is set to be higher than that of the other device electrode and the device is driven, the carbon film connected to the other device electrode through the electroconductive film corresponds to an emitter. Thus, it is presumed that a number of electron-emitting regions exist in a portion constructing the edge of the carbon film, that is, an outer edge of the second gap. That is, it is consumed that a number of electron-emitting regions are arranged along the second gap at the edge of the carbon film connected to the device electrode to which a low electric potential is applied and each electron-emitting region is electrically connected by a resistance value which the carbon film has. Therefore, even if the electroconductive film having a sheet resistance larger than that of the carbon film is arranged, there is a case where the fluctuation of the electron-emission amount is not sufficiently suppressed due to a coupling resistance of the electron-emitting regions arranged at the edge of the carbon film.

Consequently, in the electron source in which a number of electron-emitting devices are arranged, the fluctuation in electron-emission amount which is considered to be caused by the resistance value of the electroconductive film or a coupling resistance of the carbon film occurs. In the image display apparatus using the electron-emitting devices, there is a case where a luminance variation or luminance fluctuation of adjacent pixels which is considered to be caused by the fluctuation in electron-emission amount occurs. It is, thus, difficult to obtain a high-fine and good display image.

### SUMMARY OF THE INVENTION

In consideration of the above problems, therefore, it is an object of the invention to provide an electron-emitting device having stable electron-emitting characteristics with a little fluctuation for a long time.

It is another object of the invention to provide an image display apparatus having a long life with a little fluctuation for a long time by using electron-emitting devices each having stable electron-emitting characteristics with a little fluctuation for a long time.

Further features of the present invention will become apparent from the following description of exemplary embodiments with reference to the attached drawings.

### BRIEF DESCRIPTION OF THE DRAWINGS

FIGS. 1A, 1B, 1C and 1D are diagrams schematically illustrating an example of a construction of a first electron-emitting device of the invention.

FIGS. 2A and 2B are schematic diagrams illustrating manufacturing steps of the electron-emitting device in FIGS. 1A, 1B, 1C and 1D.

FIGS. 3A and 3B are schematic diagrams illustrating manufacturing steps of the electron-emitting device in FIGS. 1A, 1B, 1C and 1D.

FIGS. 4A, 4B, 4C and 4D are diagrams schematically illustrating an example of a construction of a second electron-emitting device of the invention.

FIGS. 5A and 5B are schematic diagrams illustrating manufacturing steps of the electron-emitting device in FIGS. 4A, 4B, 4C and 4D.

FIGS. 6A and 6B are schematic diagrams illustrating manufacturing steps of the electron-emitting device in FIGS. 4A, 4B, 4C and 4D.

FIG. 7 is a schematic diagram illustrating an example of a pulse which is applied at the time of a forming operation of the electron-emitting device of the invention.

FIG. 8 is a schematic diagram illustrating an example of a pulse which is applied at the time of an activation operation of the electron-emitting device of the invention.

FIG. 9 is a schematic diagram illustrating a construction of a display panel using the electron-emitting devices of the invention.

FIG. 10 is a schematic plan view illustrating manufacturing steps of an electron source of an embodiment 3 of the invention, respectively.

FIG. 11 is a schematic plan view illustrating manufacturing steps of an electron source of an embodiment 3 of the invention, respectively.

FIG. 12 is a schematic plan view illustrating manufacturing steps of an electron source of an embodiment 3 of the invention, respectively.

FIG. 13 is a schematic plan view illustrating manufacturing steps of an electron source of an embodiment 3 of the invention, respectively.

FIG. 14 is a schematic plan view illustrating manufacturing steps of an electron source of an embodiment 3 of the invention, respectively.

### DESCRIPTION OF THE EMBODIMENTS

According to the first invention, there is provided an electron-emitting device comprising at least: a pair of device electrodes formed on an insulating substrate; and an electroconductive film formed so as to connect the device electrodes, wherein the insulating substrate has a plurality of concave portions in a gap between the device electrodes in a direction along the gap, the electroconductive film has opening portions in regions corresponding to the concave portions and has a first gap in a region adjacent to the opening portions in the direction along the gap between the device electrodes, a carbon film having a second gap is formed in the first gap of the electroconductive film, the carbon film has extending portions extending from side surfaces of the concave portions toward bottom surfaces, and the extending portions of the carbon film which are neighboring through the opening portion are not coupled with each other.

According to the second invention, there is provided an electron-emitting device comprising at least: a pair of device electrodes formed on an insulating substrate; and an electroconductive film formed so as to connect the device electrodes, wherein the insulating substrate has a plurality of concave portions in a gap between the device electrodes in a direction along the gap, the electroconductive film has opening portions in regions adjacent to the concave portions in the direction along the gap between the device electrodes and has a first gap in a region arranged in the concave portion, a carbon film having a second gap is formed in the first gap of the electroconductive film, the carbon film has extending portions extending from side surfaces of the concave portions toward an upper surface of the insulating substrate, and the extending portions of the carbon film arranged in the adjacent concave portions are not coupled with each other.

According to the third invention, there is provided an image display apparatus in which a first substrate on which a plurality of electron-emitting devices are arranged and a second substrate on which image display members to which electrons emitted from the electron-emitting devices are irradiated are arranged in opposition to the electron-emitting devices are arranged so as to face each other.

According to the invention, the image display apparatus in which the good electron-emitting characteristics can be maintained for a long time, so that a display image of high quality with a little luminance change can be displayed can be provided.

The electron-emitting device and its manufacturing method according to the invention will be described hereinbelow. However, the following materials and values are shown as examples. As for the materials, values, and the like mentioned above, modifications of various kinds of materials and values can be adopted so as to be fitted to their applications within the purview of the invention where the objects and advantages of the invention are accomplished.

Various embodiments of the electron-emitting device of the invention will be described hereinbelow.

### First Embodiment

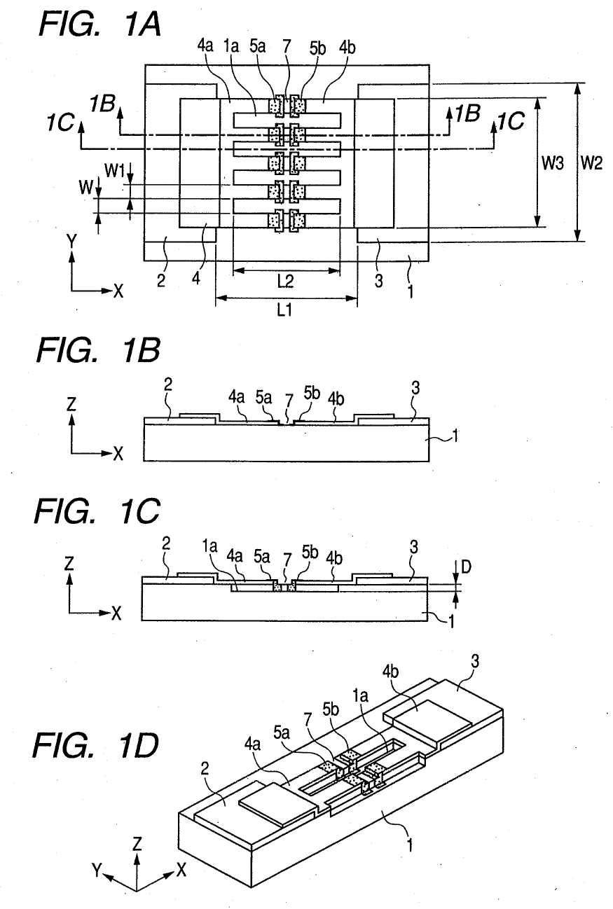

First, a fundamental construction of a most typical embodiment of the first electron-emitting device of the invention will be described with reference to FIGS. 1A to 1D. FIG. 1A is a schematic plan view illustrating a typical construction in the embodiment. FIG. 1B is a schematic cross sectional view taken along the line 1B-1B in FIG. 1A. FIG. 1C is a schematic cross sectional view taken along the line 1C-1C in FIG. 1A. FIG. 1D is a perspective view cut along the line 1C-1C in FIG. 1A.

In the invention, a facing direction of device electrodes 2 and 3 is assumed to be an X direction, a direction which perpendicularly crosses the facing direction (direction along a gap 7 between the device electrodes) is assumed to be a Y direction, and a normal direction of a substrate 1 is assumed to be a Z direction.

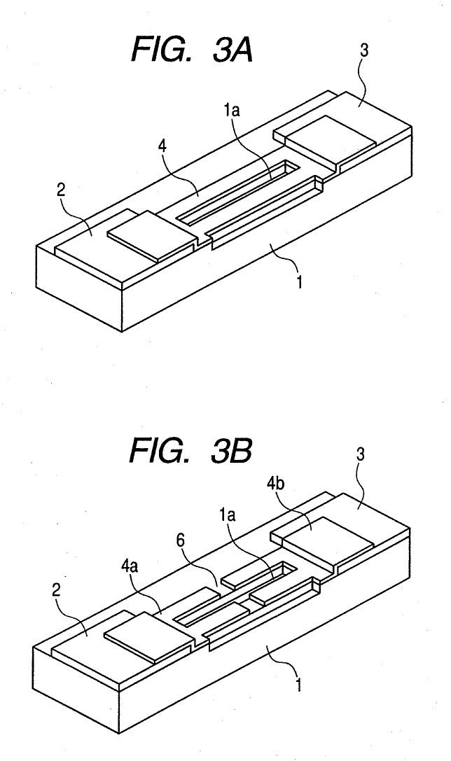

The device electrodes 2 and 3 are arranged on the insulating substrate 1 so as to be away from each other at a distance L1. The device electrode 2 and a carbon film 5a are connected by an electroconductive film 4a. The device electrode 3 and a carbon film 5b are connected by an electroconductive film 4b. The electroconductive film 4a and the electroconductive film 4b are arranged so as to face each other through a first gap 6 (refer to FIGS. 3A and 3B). The carbon films 5a and 5b are arranged so as to face each other through the second gap 7. In the gap between the device electrodes 2 and 3, a plurality of concave portions 1a are formed in the Y direction on the insulating substrate 1. In a region corresponding to the concave portion 1a, the electroconductive film 4a has an opening portion. Although the concave portion 1a of the insulating substrate 1 and the opening portion of the electroconductive film 4a are constructed so as to coincide with each other in the embodiment, the opening portion of the electroconductive film 4a may be formed wider than the concave portion 1a of the insulating substrate 1. The gap 6 between the electroconductive films 4a and 4b is arranged in a region adjacent to the concave portion 1a in the Y direction.

A width of second gap 7 is practically set to a value within a range from 1 nm or more to 10 nm or less in order to set a driving voltage to 30V or less and to suppress a discharge caused by an unexpected voltage fluctuation upon driving in consideration of costs of a driver and the like.

The carbon films 5a and 5b are illustrated as two films which are perfectly separated in FIGS. 1A to 1D. However, since the gap 7 has a very narrow width as mentioned above, the gap 7, the carbon film 5a, and the carbon film 5b can be collectively expressed as “carbon films having the gap”. Therefore, the electron-emitting device of the invention can be regarded as an electron-emitting device in which upon driving, by applying a voltage between an end portion of one of the carbon films 5a and 5b having the gap and the other end portion, the electron is emitted.

There is also a case where the carbon film 5a and the carbon film 5b are coupled by an extremely small region. So long as an extremely small region, since such a region has a high resistance, an influence on the electron-emitting characteristics is limited, so that it can be permitted. Such a form that the carbon films 5a and 5b are partially coupled can be also expressed as “carbon films having the gap”.

An example in which the gap 7 is rectilinear is illustrated in FIG. 1A. However, although it is desirable that the gap 7 is rectilinear, it is not limited to the rectilinear shape. A predetermined shape such as shape in which it is bent with a specific periodicity, arcuate shape, or shape obtained by combining arcs and straight lines may be used.

The gap 7 is formed when an edge (outer edge) of the carbon film 5a and an edge (outer edge) of the carbon film 5b face each other.

In the electron-emitting device, for example, in the case where an electric potential higher than that of the device electrode 2 is applied to the device electrode 3 upon driving (when the electron is emitted), it is considered that a number of electron-emitting regions exist in a part of the edge of the carbon film 5a, that is, in a portion constructing an outer edge of the gap 7. It is considered that the carbon film 5a connected to the device electrode 2 corresponds to an emitter. That is, it is considered that a number of electron-emitting regions exist in a part of the edge of the carbon film 5a, that is, in a portion constructing an outer edge of the gap 7.

The gap 7 can be also formed by executing various kinds of high-fine working methods of a nanoscale such as an FIB (Focused Ion Beam) or the like to the electroconductive films. Therefore, the gap 7 of the electron-emitting device of the invention is not limited to a gap which is formed by the “energization forming” operation or the “activation” operation, which will be described hereinafter, so long as those plurality of electroconductive films are electrically independent.

In the embodiment, in a region where the plurality of carbon films 5a and 5b and the electroconductive films 4a and 4b mentioned above are not formed, an activation suppressing layer (not shown) is formed so as to be come into contact with each of those films. It is desirable to form the activation suppressing layer before the gap 7 in which a number of electron-emitting regions exist is formed by an activation operation, which will be described hereinafter. The reason of it is that when a main component of the substrate 1 is an activation accelerating material (SiO₂), if the activation suppressing layer is not arranged, the carbon films 5a and 5b are spread and deposited onto the substrate 1 and an electrical short-circuit occurs between the adjacent electroconductive films. However, even if the activation suppressing layer was formed, there is a case where the adjacent carbon films 5a are coupled or the adjacent carbon films 5b are coupled.

In the invention, by providing the concave portion 1a for the substrate 1, a distance between the adjacent electroconductive films 4a and a distance between the adjacent electroconductive films 4b are extended, thereby preventing the coupling of the adjacent carbon films 5a or the coupling of the adjacent carbon films 5b and preventing the electrical short-circuit. Although the carbon films 5a and 5b are extended toward the adjacent electroconductive films 4a and 4b with the elapse of time, respectively, by providing the concave portion 1a, such extending portions are extended toward the bottom surface of the concave portion 1a. Therefore, the activating step is finished before the carbon films 5a or the carbon films 5b deposited on the adjacent electroconductive films 4a and 4b are coupled with each other. Consequently, the fluctuation in electron-emission amount can be suppressed.

As a material of the electroconductive films 4a and 4b, an electroconductive material such as metal, semiconductor, or the like can be used. For example, a metal such as Pb, Ni, Cr, Au, Ag, Mo, W, Pt, Ti, Al, Cu, or Pd, an oxide thereof, an alloy thereof, carbon, or the like can be used.

The electroconductive films 4a and 4b are formed so that Rs (sheet resistance) lies within a range of a resistance value from 1×10² to 1×10⁷ ω/□ for the purpose of suppression of the fluctuation in electron-emission amount as an advantage of the invention. Specifically speaking, it is desirable that a film thickness showing such a resistance value lies within a range from 5 nm or more to 100 nm or less. Rs indicates the value which appears when a resistance R measured in the length direction of a film in which a thickness is equal to t, a width is equal to w, and a length is equal to 1 is set to R=Rs(1/w). When a resistivity is assumed to be ρ, Rs=ρ/t. A width W3 of the region where the electroconductive films 4a and 4b are formed is desirably set to be smaller than a width W2 of each of the device electrodes 2 and 3 (refer to FIG. 1A).

The distance L1 in the direction (X direction) in which the device electrodes 2 and 3 face each other and a film thickness of each device electrode are properly designed depending on an application form or the like of the electron-emitting device. For example, in the case where the electron-emitting devices are used in an image display apparatus such as a television, they are designed corresponding to a resolution. Particularly, since a high fineness is required in a high definition (HD) television, it is necessary to decrease a pixel size. Therefore, they are designed so that a sufficient emission current Ie is obtained in order to obtain a sufficient luminance under a condition that the size of the electron-emitting device is limited.

As a practical range of the interval L1, it is set to a range from 50 nm or more to 200 μm or less, desirably, a range from 1 μm or more to 100 μm or less. As a desirable range of a minimum width W1 of the electroconductive films 4a and 4b, it is set to a range from 9 nm or more to 36 μm or less. A film thickness of the device electrodes 2 and 3 is practically set to a range from 100 nm or more to 10 μm or less.

As a substrate 1, quartz glass, soda lime glass, a glass substrate obtained by laminating silicon oxide (typically, SiO₂) onto a glass substrate, or a glass substrate in which alkali components have been reduced can be used.

As a material of the device electrodes 2 and 3, an electroconductive material such as metal or semiconductor can be used. For example, a metal such as Ni, Cr, Au, Mo, W, Pt, Ti, Al, Cu, or Pd, an alloy thereof, a metal such as Pd, Ag, Au, RuO₂, or Pd—Ag, a metal oxide thereof, or the like can be used.

As a material of the activation suppressing layer, an oxide or a nitride of a metal, a semiconductor, or the like, or their mixture is desirably used. For example, an oxide of W, Ti, Ni, Co, Cu, Ge, or the like, a nitride of Si, Al, Ge, or the like, or their mixture can be mentioned. As a range of the practical sheet resistance of those activation suppressing layers, a range of 1×10⁴Ω/□ or more is desirable in terms of prevention of the short-circuit of the device electrodes 2 and 3 and prevention of a leakage current upon driving. Although an upper limit value of the sheet resistance is not particularly restricted, when the electron-emitting devices of the invention are used in an image display apparatus, if a function as an antistatic film is also simultaneously provided for the apparatus, a range of 1×10¹¹Ω/□ or less is desirable. It is desirable that the activation suppressing layer is formed only in the region where the electroconductive films 4a and 4b are not formed. However, even if the activation suppressing layers have been formed on the electroconductive films 4 before the gap 6 is formed, if they are extinguished or aggregated and dispersed from at least a portion near the gap 6 by a heat that is generated by the forming operation and the activation operation, no problems will occur.

Subsequently, a manufacturing method of the electron-emitting device of the embodiment will be described.

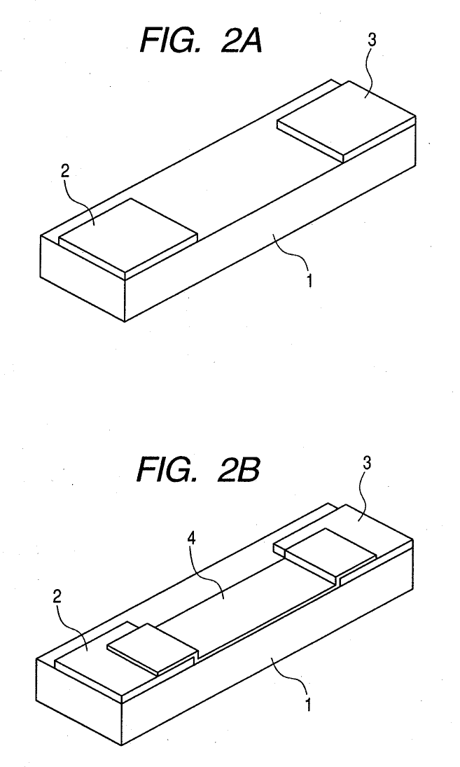

FIGS. 2A, 2B, 3A, and 3B are cross sectional schematic views illustrating manufacturing steps of the electron-emitting device illustrated as an example in FIGS. 1A to 1D. The steps will be described hereinbelow.

(Step 1)

The substrate 1 is sufficiently cleaned and a material to form the device electrodes 2 and 3 is deposited onto the substrate 1 by a vacuum evaporation depositing method, a sputtering method, or the like. The resultant substrate 1 is patterned by using a photolithography technique or the like, thereby forming the device electrodes 2 and 3 onto the substrate 1 (FIG. 2A).

(Step 2)

Subsequently, the electroconductive film 4 which connects the device electrodes 2 and 3 formed on the substrate 1 is formed (FIG. 2B).

As a forming method of the electroconductive film 4, for example, first, by coating a film with an organic metal solution and drying, an organic metal film is formed. The organic metal film is heat baking processed, thereby obtaining a metal film or a metal compound film such as a metal oxide film. After that, a mask is formed onto the electroconductive film 4 and patterned by etching or the like, thereby obtaining the electroconductive film 4 having the opening portion. At the same time, the concave portion 1a is formed on the substrate 1 in the opening portion by dry etching by using the mask (FIG. 3C). At this time, as a material of the electroconductive film 4, an electroconductive material such as metal, semiconductor, or the like can be used. For example, a metal such as Ni, Cr, Au, Mo, W, Pt, Ti, Al, Cu, or Pd, a metal compound (alloy, metal oxide, or the like) thereof, or the like can be used.

Although the forming method has been described based on the coating method of the organic metal solution here, the forming method of the electroconductive film 4 is not limited to it. For example, the electroconductive film 4 can be also formed by a well-known method such as vacuum evaporation depositing method, sputtering method, CVD method, dispersion coating method, dipping method, spinner method, or ink-jet method.

The electroconductive film 4 is formed under a condition that Rs (sheet resistance) lies within a range of the resistance value from 10²Ω/□ or more to 10⁷Ω/□ or less.

The order of steps 2 and 1 can be also exchanged. That is, after cleaning the substrate, the electroconductive film 4 and the opening portion are formed and, thereafter, the device electrodes 2 and 3 may be formed.

As a depth D of the concave portion 1a, now assuming that a width of opening portion is set to W and a length of carbon films 5a and 5b extending from the edge of the opening portion into the concave portion 1a is set to M, the depth D can be decided so as to satisfy (M≦D+W/2). M is properly decided based on the material of a side surface of the concave portion 1a, activating conditions, and the like. For example, in the case of SiO₂ as an activation accelerating material, a value of M is equal to about hundreds of nm to 10 μm. In the case of the metal oxide (containing W, Ge, etc.) as an activation suppressing material, it is equal to about 10 nm to 1 μm. Therefore, if the width W1 and a pitch of the electroconductive films 4a and 4b near the gap 7 serving as an electron-emitting region are determined, W is obtained and D can be properly decided. For example, now assuming that W1=150 nm, the pitch=300 nm, and M=200 nm, W=150 nm and it is desirable to set the value of D to (D≧200−150/2=125 nm).

(Step 3)

Subsequently, in order to further effectively accomplish the prevention of the coupling of the carbon films 5a or the carbon films 5b which are neighboring in the Y direction, the electroconductive film 4 is patterned and the activation suppressing layer (not shown) is formed as necessary onto the substrate 1 with the concave portion 1a. As mentioned above, as a material of the activation suppressing layer, an oxide or a nitride of a metal, a semiconductor, or the like, or their mixture is desirably used. For example, an oxide of W, Ti, Ni, Co, Cu, Ge, or the like, a nitride of Si, Al, Ge, or the like, or their mixture can be mentioned. The forming method of the activation suppressing layer is not limited to it. For example, the activation suppressing layer can be also formed by the well-known method such as vacuum evaporation depositing method, sputtering method, CVD method, dispersion coating method, dipping method, spinner method, or ink-jet method.

(Step 4)

Subsequently, the first gap 6 is formed in the electroconductive film 4. A patterning method using an EB lithography method can be adopted as a forming method of the gap 6. The gap 6 can be formed at a predetermined position of the electroconductive film 4 by irradiating an FIB (Focused Ion Beam) to a portion of the electroconductive film 4 where it is intended to form the gap 6.

The gap 6 can be also formed in a part of the electroconductive film 4 by supplying a current to the electroconductive film 4 by the well-known “energization forming” operation. Specifically speaking, by applying a voltage between the device electrodes 2 and 3, the current can be supplied to the electroconductive film 4.

By the above steps, the electroconductive films 4a and 4b are arranged in the X direction so as to face each other through the first gap 6 (FIG. 3D). There is also a case where the electroconductive films 4a and 4b are coupled through a micro portion.

The energization forming operation can be executed by repetitively applying a pulse voltage whose pulse peak value is set to a predetermined (constant) voltage between the device electrodes 2 and 3. The energization forming operation can be also executed by applying the pulse voltage while gradually increasing the pulse peak value. A triangular wave or a rectangular wave can be used as a waveform itself of the pulse which is applied.

The peak value, a pulse width, a pulse interval, and the like are not limited to the values mentioned above. Proper values can be selected according to a resistance value or the like of the electron-emitting device so that the first gap 6 is desirably formed.

(Step 5)

Subsequently, the activation operation is executed. The activation operation is executed by introducing a carbon-contained gas into a vacuum apparatus and applying a bipolar pulse voltage between the device electrodes 2 and 3 a plurality of number of times in an atmosphere containing the carbon-contained gas. That is, the bipolar pulse voltage is applied to the electroconductive films 4a and 4b a plurality of number of times.

By the above process, the carbon films 5a and 5b can be formed onto the substrate 1 by the carbon-contained gas existing in the atmosphere. Specifically speaking, the carbon films 5a and 5b are deposited onto the substrate 1 between the electroconductive films 4a and 4b (in the gap 6) and onto the electroconductive films 4a and 4b near such portions. That is, the carbon films 5a and 5b which are arranged so as to face each other through the gap 7 are formed onto the substrate 1.

For example, an organic substance gas can be used as a carbon-contained gas mentioned above. As an organic substance, an aliphatic hydrocarbon class of alkane, alkene, or alkyne, an aromatic hydrocarbon class, an alcohol class, an aldehyde class, a ketone class, an amine class, an organic acid class such as phenol, carvone, or sulfonic acid, or the like can be mentioned. Specifically speaking, saturated hydrocarbon expressed by CₙH₂ₙ₊₂ such as methane, ethane, or propane or unsaturated hydrocarbon expressed by a composition formula such as CₙH₂ₙ such as ethylene or propylene can be used. Benzene, toluene, methanol, ethanol, formaldehyde, acetaldehyde, acetone, methyl ethyl ketone, methylamine, ethylamine, phenol, formic acid, acetic acid, propionic acid, or the like can be also used. Particularly, trinitrile is desirably used.

A waveform of the bipolar pulse voltage which is applied during the activation operation is a waveform adapted to reverse the relation between the electric potentials of the device electrodes 2 and 3 at predetermined timing or at a predetermined cycle. In the reversal of the relation between the electric potentials, such a waveform in which the electric potentials are alternately reversed is desirable. However, the invention is not necessarily limited to such an example in which they are alternately reversed.

The electron-emitting device illustrated in FIGS. 1A to 1D can be formed by the foregoing steps 1 to 5.

The produced electron-emitting device is subjected to, desirably, a stabilization operation as a process for heating in the vacuum prior to executing the driving (prior to irradiating an electron beam to phosphor in the case of applying it to the image display apparatus). It is desirable that surplus carbon and organic substance deposited on the surface of the substrate 1 or other portions by the foregoing activation operation and the like is removed by executing the stabilization operation.

Specifically speaking, surplus carbon and organic substance are exhausted in the vacuum apparatus. Although it is desirable to remove the organic substance in the vacuum apparatus as much as possible, it is desirable to remove the organic substance down to a partial pressure of 1×10⁻⁸ Pa or less. It is desirable that a total pressure in a vacuum chamber also containing gases other than the organic substance is equal to 3×10⁻⁶ Pa or less.

As for the atmosphere at the time of driving the electron-emitting device after the stabilization operation was executed, it is desirable to maintain the atmosphere at the end of the stabilization operation. However, the invention is not limited to it. If the organic substance has sufficiently been removed, even when the pressure itself rises slightly, the sufficient stable characteristics can be maintained.

The electron-emitting device of the invention can be formed by the above steps.

### Second Embodiment

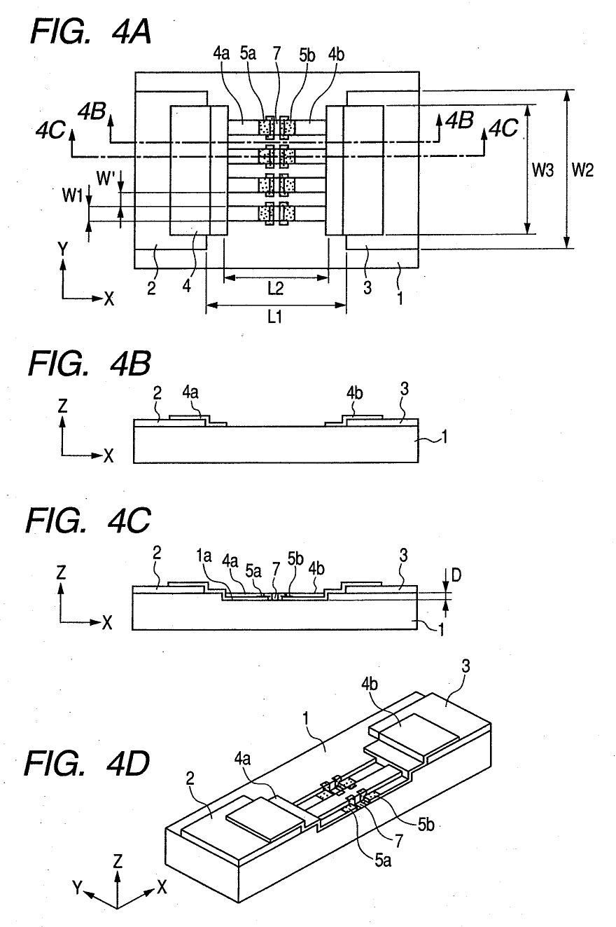

A fundamental construction of a most typical embodiment of a second electron-emitting device of the invention will be described with reference to FIGS. 4A to 4D. FIG. 4A is a schematic plan view illustrating a typical construction in the embodiment. FIG. 4B is a schematic cross sectional view taken along the line 4B-4B in FIG. 4A. FIG. 4C is a schematic cross sectional view taken along the line 4C-4C in FIG. 4A. FIG. 4D is a perspective view cut along the line 4C-4C in FIG. 4A.

The electroconductive films 4a and 4b are arranged so as to face each other through the concave portion 1a formed in the insulating substrate 1 in the first embodiment. However, in the second embodiment, on the contrary, the electroconductive films 4a and 4b are arranged in the concave portion and the opening portions of the electroconductive films 4a and 4b are arranged in the region (on the surface of the substrate 1) adjacent to the concave portion 1a in the Y direction. In the embodiment, as illustrated in FIG. 4D, extending portions extending from the carbon films 5a and 5b are extended along the side surface of the concave portion 1a in the direction of the upper surface of the substrate 1. However, since a distance is extended by the concave portion 1a, they are not coupled with each other, so that the electrical short-circuit is prevented.

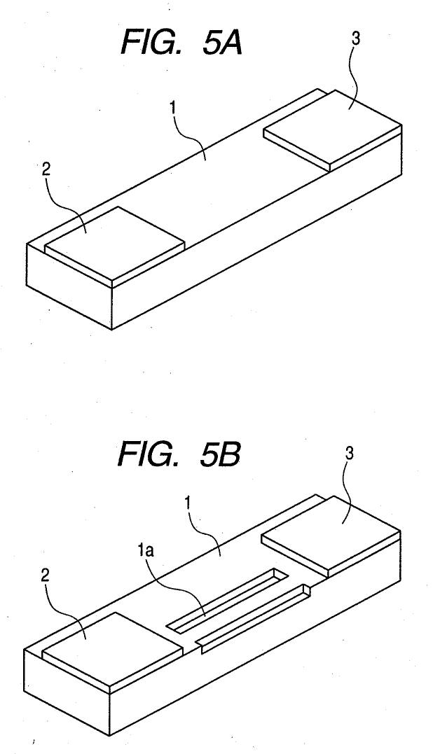

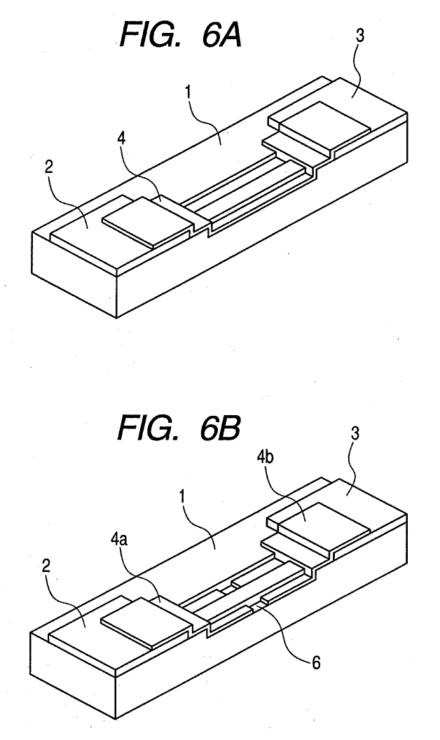

Subsequently, a manufacturing method of the electron-emitting device of the embodiment will be described with reference to FIGS. 5A, 5B, 6A, and 6B.

(Step 1)

The device electrodes 2 and 3 are formed on the substrate 1 in a manner similar to step 1 in the first embodiment (FIG. 5A).

(Step 2)

A plurality of concave portions 1a are formed in the gap between the device electrodes on the substrate 1 by dry etching or the like (FIG. 5B).

(Step 3)

The electroconductive film 4 which connects the device electrodes 2 and 3 is formed in a manner similar to step 2 in the first embodiment. The electroconductive film 4 is patterned in such a manner that the electroconductive film 4 remains in the concave portion 1a and the region adjacent to the concave portion 1a in the Y direction becomes the opening portion (FIG. 6A).

(Step 4)

The gap 6 is formed in the electroconductive film 4 in the concave portion 1a in a manner similar to step 4 in the first embodiment (FIG. 6B).

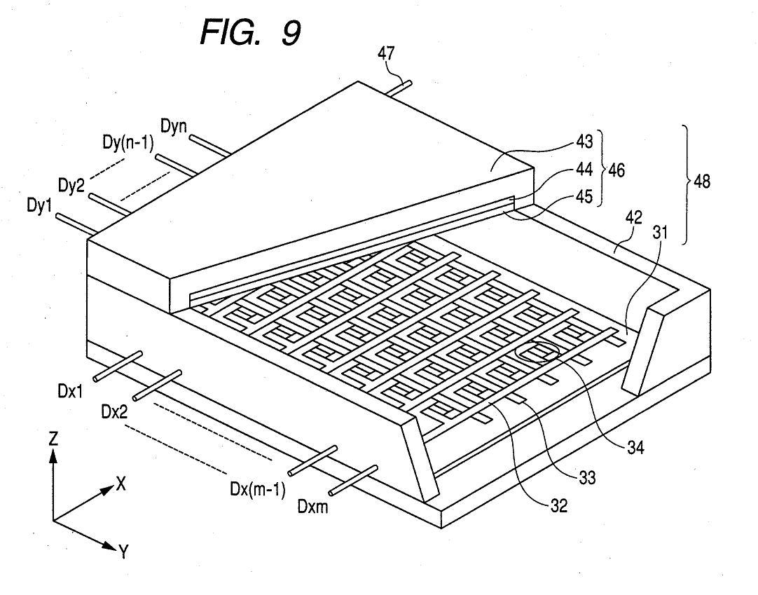

Subsequently, an example of an image display apparatus constructed by using the electron-emitting devices of the invention will be described with reference to FIG. 9. FIG. 9 is a fundamental constructional diagram illustrating a display panel constructing the image display apparatus of the invention with a part cut away.

In FIG. 9, a plurality of electron-emitting devices 34 of the invention are arranged in a matrix form onto an electron source substrate (rear plate, first substrate) 31. A face plate (second substrate) 46 is constructed by forming a phosphor film 44 and a metal back 45 or the like onto an inner surface of a transparent substrate 43 made of glass or the like. A supporting frame 42 is arranged between the face plate 46 and the rear plate 31. The rear plate 31, supporting frame 42, and face plate 46 are seal-bonded to a joint portion by applying an adhesive such as frit glass, indium, or the like. An envelope 48 is constructed by such a seal-bonded structure.

A supporting member (not shown) called a spacer is arranged between the face plate 46 and the rear plate 31 as necessary, so that the envelope 48 having an enough strength against the atmospheric pressure can be constructed.

Each of the electron-emitting devices 34 in the envelope 48 is connected to X-directional wirings 32 and Y-directional wirings 33 mentioned above. Therefore, electrons can be emitted from desired electron-emitting devices 34 by applying a voltage through terminals Dx1 to Dxm and Dy1 to Dyn connected to the electron-emitting devices 34, respectively. At this time, the voltage in a range from 5 kV or more to 30 kV or less, desirably, a range from 10 kV or more to 25 kV or less is applied to the metal back 45 through a high-voltage terminal 47. An interval between the face plate 46 and the substrate 31 is set to a value within a range from 1 mm or more to 5 mm or less, desirably, a range from 1 mm or more to 3 mm or less. By setting as mentioned above, the electrons emitted from the selected electron-emitting devices pass through the metal back 45 and collide with the phosphor film 44. An image is displayed by exciting phosphor so as to emit light.

In the construction mentioned above, detailed portions such as materials and the like of the respective members are not limited to the foregoing contents but may be properly modified according to the object.

### EXAMPLES

The invention will be described further in detail hereinbelow by mentioning Examples.

### Example 1

In this Example, an example in which the electron-emitting device described in the first embodiment was manufactured is shown. A construction of the electron-emitting device in this Example is similar to that illustrated in FIGS. 1A to 1D. A fundamental construction and a manufacturing method of the electron-emitting device in this Example will be described with reference to FIGS. 1A to 1D, 3A, and 3B.

(Step-a)

First, a Ti film having a thickness of 5 nm is formed onto the cleaned quartz substrate 1 by using the sputtering method. After that, a Pt film having a thickness of 40 nm is formed onto the Ti film. Subsequently, the device electrodes 2 and 3 are pattern-formed onto the substrate 1 by using a photolithography method. Two kinds of devices in which the interval L1 between the device electrodes is respectively equal to 20 μm and 100 μm are manufactured. The width W2 of the device electrodes 2 and 3 is set to 500 μm (FIG. 2A).

(Step-b)

Subsequently, each of the substrates 1 obtained by step-a is spin-coated with an organic palladium compound solution and, thereafter, a heat baking process is executed. The electroconductive film 4 containing Pd as a main element is formed in this manner FIG. 2B.

Subsequently, the electroconductive film 4 is patterned by the photolithography method using a stepper, the opening portions are formed, and the electroconductive film 4 is partially divided into a plurality of portions by the opening portions. Further, the surface of the substrate 1 in the opening portion of the electroconductive film is subsequently dug down by dry etching by using an electroconductive film patterning mask, thereby forming the concave portion 1a having a depth of 0.5 μm (FIG. 3A). The width W1 of the electroconductive film 4 is set to 1 μm and the interval (width of the opening portion, that is, the concave portion 1a) W between the adjacent electroconductive films 4 is set to the same value as the width W1. The net whole width W3 of the electroconductive film 4 is set to 180 μm. Therefore, the number of electroconductive films 4 in the regions divided by the opening portions is equal to 180/(2×W1)=90. The Rs (sheet resistance) of the electroconductive film 4 is set to 1×10⁴Ω/□ and a film thickness is set to 10 nm.

(Step-c)

A mixture layer of Sb (antimony) and SnO₂ (tin oxide) is formed as an activation suppressing layer by using the sputtering method onto each substrate 1 obtained by step-b. A film thickness of the mixture layer is equal to 10 nm and the Rs (sheet resistance) is equal to 2×10¹⁰Ω/□.

(Step-d)

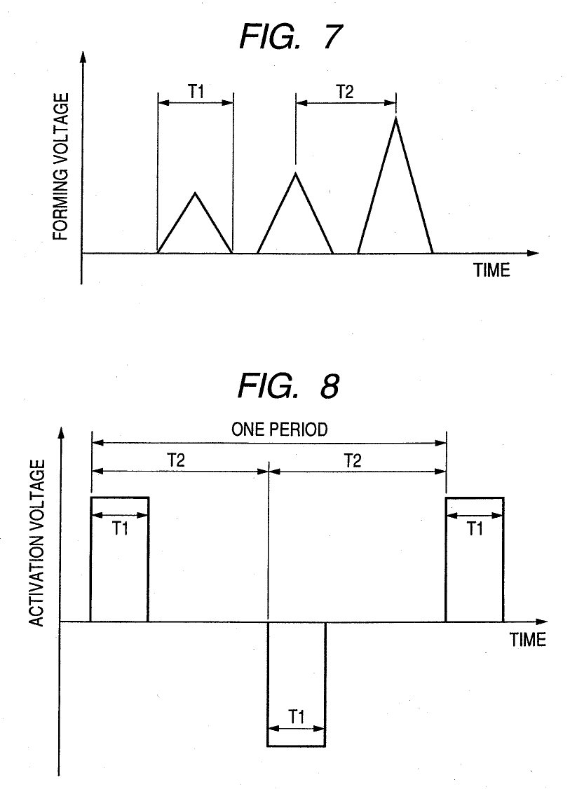

Each substrate 1 obtained by step-a to step-c is set into the vacuum apparatus and evacuated by a vacuum pump. After a pressure in the vacuum apparatus reached a vacuum degree of 1×10⁻⁶ Pa, a voltage Vf is applied between the device electrodes 2 and 3, the forming operation is executed, and the gap 6 is formed in the electroconductive film 4, thereby forming the electroconductive films 4a and 4b (FIG. 3B). The waveform illustrated in FIG. 7 is used as a voltage waveform in the forming operation.

In FIG. 7, in this Example, T1 is set to 1 msec, T2 is set to 16.7 msec, and a peak value of a triangular wave is raised step by step by 0.1V, thereby executing the forming operation. During the forming operation, a resistance measuring pulse of a voltage of 0.1V is intermittently applied between the device electrodes 2 and 3 and a resistance is measured. The forming operation is finished at a point of time when a value measured by the resistance measuring pulse has reached about 1 MΩ or more.

(Step-e)

Subsequently, the activation operation is executed. Specifically speaking, trinitrile is introduced into the vacuum apparatus. After that, a pulse voltage of the waveform illustrated in FIG. 8 is applied between the device electrodes 2 and 3 under such conditions that the maximum voltage value is equal to ±20V, T1 is equal to 1 msec, and T2 is equal to 10 msec. After starting the activation operation, it is confirmed that a device current If has entered a gentle rising state. The voltage applying operation is stopped and the activation operation is finished. Thus, the carbon films 5a and 5b are formed (FIGS. 2A and 2B). The electron-emitting device is formed by the above steps.

(Step-f)

Subsequently, the stabilization operation is executed to each electron-emitting device. Specifically speaking, while the vacuum apparatus and the electron-emitting device are heated by a heater and their temperatures are maintained at about 250° C., the evacuation of the inside of the vacuum apparatus is continued. After the elapse of 20 hours, the heating operation by the heater is stopped and the temperature is returned to a room temperature, so that a pressure in the vacuum apparatus reaches about 1×10⁻⁸ Pa.

Subsequently, a practical driving is executed to each device and the emission current Ie is measured for a long time. In the practical driving, a distance H between the anode electrode and the electron-emitting device is set to 2 mm. An electric potential of 5 kV is applied to the anode electrode. A rectangular pulse voltage in which a peak value is equal to 17V, a pulse width is equal to 100 μsec, and a frequency is equal to 60 Hz is applied between the device electrodes 2 and 3 of each electron-emitting device.

The emission current Ie of each electron-emitting device in this Example is measured by an ammeter. A fluctuation value of the emission current Ie is obtained by measuring it at the same measurement time interval a plurality of number of times in each device and calculating (standard deviation/mean value×100(%)) of a plurality of obtained data. The fluctuation value of the emission current Ie of each device is shown in the following Table 1. For comparison, the fluctuation value of the emission current Ie of each electron-emitting device in the case where the concave portion 1a is not formed in the substrate 1 in the opening portion in foregoing step-b is shown in the following Table 2.

TABLE 1

| L1 | W1 | W1/L1 | Ie fluctuation |
|---|---|---|---|
| 20 μm | 1 μm | 0.05 | 5.7% |
| 100 μm | 1 μm | 0.01 | 5.0% |

TABLE 2

| L1 | W1 | W1/L1 | Ie fluctuation |
|---|---|---|---|
| 20 μm | 1 μm | 0.05 | 15.3% |
| 100 μm | 1 μm | 0.01 | 12.5% |

After the emission currents Ie were measured, each device is observed by an optical microscope and an SEM (Scanning Electron Microscope). Thus, in the case where the concave portion 1a was formed in the opening portion, the short-circuit due to the carbon films 5a and the carbon films 5b is not caused in the adjacent electroconductive films 4a and 4b in each device. In this instance, a mean value of the lengths M of the extending portions extending from the carbon films 5a and 5b into the concave portion 1a is equal to about 0.7 μm. On the other hand, in the case where the concave portion 1a is not formed, portions where the short-circuit has been caused in the adjacent electroconductive films 4a and 4b by the coupling of the carbon films 5a and the carbon films 5b were confirmed.

From those results, it has been found that in the case where the concave portion 1a was formed, the coupling of the adjacent carbon films is blocked and the fluctuation of the emission current Ie is effectively suppressed.

### Example 2

In this Example, an example in which the electron-emitting device described in the second embodiment was manufactured is shown. A construction of the electron-emitting device in this Example is similar to that illustrated in FIGS. 4A to 4D. A fundamental construction and a manufacturing method of the electron-emitting device in this Example will be described with reference to FIGS. 4A to 4D, 6A, and 6B.

(Step-a)

The device electrodes 2 and 3 are formed onto the quartz substrate 1 in a manner similar to step-a in Example 1 (FIG. 5A).

(Step-b)

Subsequently, each substrate 1 obtained by step-a is patterned by the photolithography method using the stepper, the surface of the substrate 1 is dug down by the dry etching, thereby forming the concave portion 1a having a depth of 0.1 μm (FIG. 5B). Subsequently, each of the substrates 1 is spin-coated with the organic palladium compound solution and, thereafter, the heat baking process is executed. The electroconductive film 4 containing Pd as a main element is formed in this manner. Subsequently, the electroconductive film 4 is left in the concave portion 1a and the electroconductive film 4 is patterned by the photolithography method so as to form the opening portions onto the substrate 1 adjacent to the concave portion 1a in the Y direction. In this manner, the electroconductive films 4 formed in the plurality of concave portions 1a and the device electrodes 2 and 3 connected to the electroconductive films 4 are formed (FIG. 6A). At this time, the width W1 of the electroconductive film 4 in the concave portion 1a is set to 200 nm and the interval W between the adjacent electroconductive films 4 is set to the same value as the width W1. The net whole width W3 of the electroconductive film 4 is set to 180 μm. Therefore, the number of portions obtained by partially dividing the electroconductive films 4 in each device is equal to 180/(2×W1)=450. The Rs (sheet resistance) of the electroconductive film 4 is equal to 1×10⁴Ω/□ and the film thickness is set to 10 nm.

(Step-c)

Subsequently, a mixture layer of W (tungsten) and GeN (germanium nitride) is formed as an activation suppressing layer by using the sputtering method onto each substrate 1 obtained by step-b. A film thickness of the mixture layer is equal to 10 nm and the Rs (sheet resistance) is equal to 2×10¹⁰Ω/□.

(Step-d)

Subsequently, the forming operation is executed in a manner similar to step-d in Example 1, the gap 6 is formed in the electroconductive film 4, and the electroconductive films 4a and 4b are formed (FIG. 6B).

(Step-e)

Subsequently, the activation operation is executed in a manner similar to step-e in Example 1 and the carbon films 5a and 5b are formed (FIGS. 4A to 4D)

(Step-f)

Subsequently, the stabilization operation is executed in a manner similar to step-f in Example 1.

Subsequently, the emission current Ie is measured for a long time in a manner similar to Example 1. A fluctuation value of the emission current Ie of each device is shown in the following Table 3. For comparison, the fluctuation value of the emission current Ie of each electron-emitting device in the case where the concave portion 1a is not formed in foregoing step-b is shown in the following Table 4.

TABLE 3

| L1 | W1 | W1/L1 | Ie fluctuation |
|---|---|---|---|
| 20 μm | 200 nm | 0.01 | 4.8% |
| 100 μm | 200 nm | 0.002 | 4.5% |

TABLE 4

| L1 | W1 | W1/L1 | Ie fluctuation |
|---|---|---|---|
| 20 μm | 200 nm | 0.01 | 11.7% |
| 100 μm | 200 nm | 0.002 | 10.2% |

After the emission currents Ie were measured, each device is observed by the optical microscope and the SEM (Scanning Electron Microscope). Thus, in the case where the concave portion 1a was formed, the short-circuit due to the carbon films 5a and the carbon films 5b is not caused in the adjacent electroconductive films 4a and 4b in each device. In this instance, the mean value of the lengths M of the extending portions extending from the carbon films 5a and 5b into the concave portion 1a is equal to about 0.15 μm. On the other hand, in the case where the concave portion 1a is not formed, portions where the short-circuit has been caused in the adjacent electroconductive films 4a and 4b by the coupling of the carbon films 5a and the carbon films 5b were confirmed.

From those results, it has been found that even in the case where the electroconductive films had densely been formed in the limited regions, if the concave portion 1a was formed, the coupling of the adjacent carbon films is blocked and the fluctuation of the emission current Ie is effectively suppressed.

### Example 3

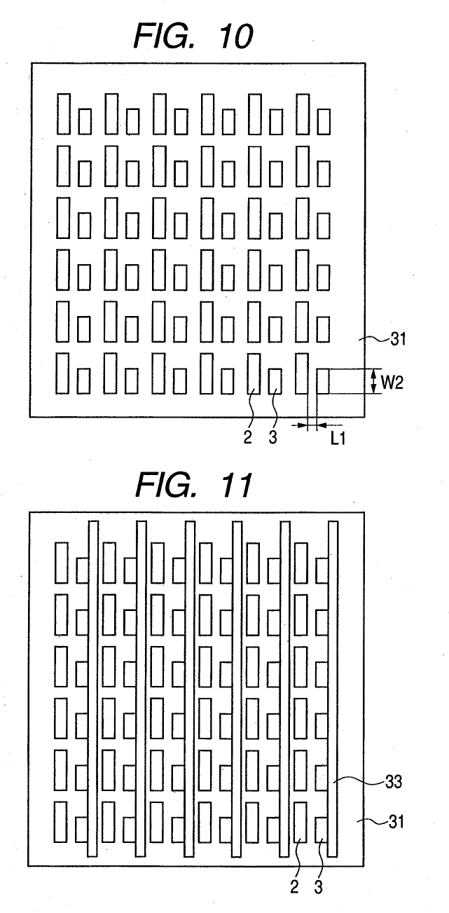

In this Example, a number of electron-emitting devices formed by a manufacturing method similar to that of the electron-emitting devices formed in Example 1 mentioned above are arranged onto the substrate in a matrix form, thereby forming an electron source. Further, an image forming apparatus illustrated in FIG. 9 is formed by using the electron source. Manufacturing steps will now be described with reference to FIGS. 10 to 14.

<Device Electrode Manufacturing Step>

First, a number of device electrodes 2 and 3 are formed onto the substrate 31 (FIG. 10). Specifically speaking, a laminate film of titanium Ti and platinum Pt having a thickness of 40 nm is formed onto the substrate 31 and, thereafter, it is patterned by the photolithography method, thereby forming the device electrodes. The interval L1 between the device electrodes 2 and 3 is set to 20 μm and the length W2 is set to 200 μm.

<Y-Directional Wiring Forming Step>

Subsequently, as illustrated in FIG. 11, the Y-directional wirings 33 made of silver as a main component are formed so as to be connected to the device electrodes 3. The Y-directional wirings 33 function as wirings to which a modulation signal is supplied.

<Insulating Layer Forming Step>

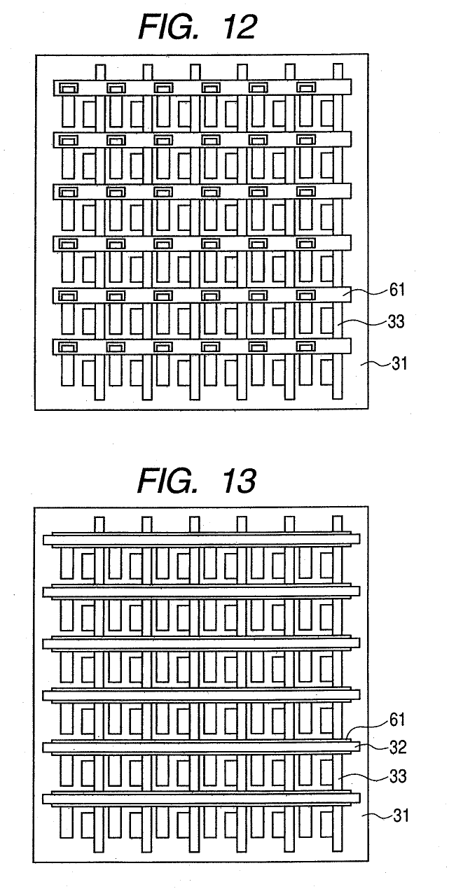

Subsequently, as illustrated in FIG. 12, in order to insulate the X-directional wirings 32 which are formed in the next step and the foregoing Y-directional wirings 33, an insulating layer 61 made of silicon oxide is formed so as to cover the Y-directional wirings 33 which have already been formed under the X-directional wirings 32, which will be described hereinafter. Contact holes are opened and formed in parts of the insulating layer 61 so that the X-directional wirings 32 and the device electrodes can be electrically connected.

<X-Directional Wiring Forming Step>

As illustrated in FIG. 13, the X-directional wirings 32 made of silver as a main component are formed onto the insulating layer 61 which has already been formed. The X-directional wirings 32 cross the Y-directional wirings 33 through the insulating layer 61 and are connected to the device electrodes 2 in the contact hole portions of the insulating layer 61. The X-directional wirings 32 function as wirings to which a scanning signal is supplied. In this manner, the substrate 31 having the matrix wirings is formed.

<Electroconductive Film Forming Step>

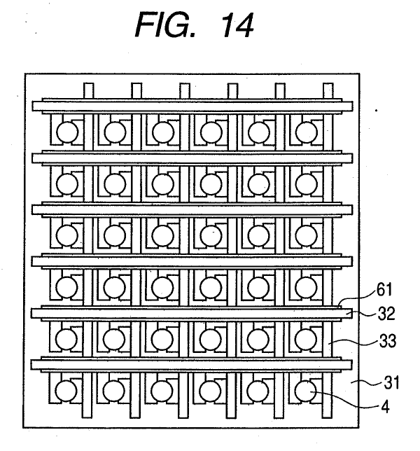

The electroconductive film 4 is formed by the ink-jet method between the device electrodes 2 and 3 on the substrate 31 on which the matrix wirings have been formed (FIG. 14). In this Example, an organic palladium complex solution is used as ink which is used in the ink-jet method. After the organic palladium complex solution was fed so as to connect the device electrodes 2 and 3, the substrate 31 is heat-baking processed in the air, thereby forming the electroconductive film 4 made of palladium oxide (PdO).

After that, the opening portions are formed in the electroconductive film 4 by using the FIB and the electroconductive film 4 is partially divided into 50 portions. W1 of the electroconductive film in each divided region is equal to 1 μm and the interval between the adjacent electroconductive films 4 is equal to 1 μm.

After that, the gap 6 is formed in each electroconductive film 4 in a manner similar to Example 1 and, thereafter, the activation operation is executed. In the activation operation, a waveform of the voltage which is applied to each unit (the pair of device electrodes 2 and 3 and the electroconductive film 4) and the like are substantially the same as those shown in the manufacturing method of the electron-emitting device in Example 1.

The substrate 31 on which the electron source (the plurality of electron-emitting devices) of this Example has been arranged is formed by the above steps.

Subsequently, as illustrated in FIG. 9, the face plate 46 obtained by stacking the phosphor film 44 and the metal back 45 onto the inner surface of the glass substrate 43 is arranged at a position that is over the substrate 31 by 2 mm through the supporting frame 42. The joint portion of the face plate 46, supporting frame 42, and substrate 31 is seal-bonded by heating indium (In) as a metal having a low melting point and subsequently cooling it. Since the seal-bonding step is executed in the vacuum chamber, the seal-bonding and the sealing are simultaneously executed without using an exhaust pipe.

In this Example, in order to display a color image, the phosphor film 44 as an image display member is constructed by the phosphor in a stripe shape. First, black stripes are formed at desired intervals. Subsequently, regions among the black stripes are coated with color phosphor materials by a slurry method, thereby forming the phosphor film 44. A material containing graphite as a main component which is ordinarily often used is used as a material of the black stripes.

The metal back 45 made of aluminum is provided on the inner surface side of the phosphor film 44 (electron-emitting device side). The metal back 45 is formed by vacuum-evaporation depositing A1 onto the inner surface side of the phosphor film 44.

The desired electron-emitting devices are selected through the X-directional wirings 32 and the Y-directional wirings 33 of the image display apparatus completed as mentioned above and the pulse voltage of 17V is applied. At the same time, by applying the voltage of 10 kV to the metal back 45 through a high-voltage terminal Hv, the bright and good image in which a luminance variation is small and a luminance fluctuation is also small can be displayed for a long time.

The embodiments and Examples described above are nothing but examples of the invention and the invention does not exclude many various modifications about the materials, sizes, and the like mentioned above.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-126629, filed May 14, 2008, which is hereby incorporated by reference herein in its entirety.

What is claimed is:

1. An electron-emitting device comprising at least:
a pair of device electrodes formed on an insulating substrate; and
an electroconductive film formed so as to connect the device electrodes,
wherein the insulating substrate has a plurality of concave portions in a gap between the device electrodes in a direction along the gap,
the electroconductive film has opening portions in regions corresponding to the concave portions and has a first gap in a region adjacent to the opening portions in the direction along the gap between the device electrodes,
a carbon film having a second gap is formed in the first gap of the electroconductive film, the carbon film has extending portions extending from side surfaces of the concave portions toward bottom surfaces, and the extending portions of the carbon film which are neighboring through the opening portion are not coupled with each other.

2. An image display apparatus in which a first substrate on which a plurality of electron-emitting devices according to claim 1 are arranged and a second substrate on which image display members to which electrons emitted from the electron-emitting devices are irradiated are arranged in opposition to the electron-emitting devices are arranged so as to face each other.

3. An electron-emitting device comprising at least:
a pair of device electrodes formed on an insulating substrate; and
an electroconductive film formed so as to connect the device electrodes,
wherein the insulating substrate has a plurality of concave portions in a gap between the device electrodes in a direction along the gap,
the electroconductive film has opening portions in regions adjacent to the concave portions in the direction along the gap between the device electrodes and has a first gap in a region arranged in the concave portion,
a carbon film having a second gap is formed in the first gap of the electroconductive film, the carbon film has extending portions extending from side surfaces of the concave portions toward an upper surface of the insulating substrate, and the extending portions of the carbon film arranged in the adjacent concave portions are not coupled with each other.

4. An image display apparatus in which a first substrate on which a plurality of electron-emitting devices according to claim 3 are arranged and a second substrate on which image display members to which electrons emitted from the electron-emitting devices are irradiated are arranged in opposition to the electron-emitting devices are arranged so as to face each other.
